(19) United States
(12) Patent Application Publication
(10) Pub. No.: US 2025/0246957 A1
(43) Pub. Date: Jul. 31, 2025

(54) ELECTRIC MACHINE WITH COOLED ROTOR BARS

(71) Applicant: FCA US LLC, Auburn Hills, MI (US)

(72) Inventors: Reemon Z.S. Haddad, Rochester Hills, MI (US); Dhafar Al-Ani, Troy, MI (US)

(21) Appl. No.: 18/426,424

(22) Filed: Jan. 30, 2024

(51) Int. Cl. H02K 1/32; H02K 15/00; H02K 17/16

(52) U.S. Cl. CPC H02K 1/32; H02K 15/023; H02K 17/168

(57) ABSTRACT

A rotor assembly includes a plurality of rotor laminations arranged in a stacked configuration, and a plurality of apertures formed in each of the rotor laminations, where the plurality of apertures of the plurality of rotor laminations are aligned to form a plurality of passages in the stacked configuration. A conductive rotor bar is disposed in each passage of the plurality of passages, and each conductive rotor bar includes at least one coolant channel formed therein and configured to receive a flow of coolant for cooling the conductive rotor bar.

### FIELD

The present application generally relates to electric machines and, more particularly, to an electric machine rotor assembly with improved rotor bar cooling.

### BACKGROUND

An induction machine, also known as an asynchronous machine, operates on the principle of electromagnetic induction and includes a stationary part known as the stator, which houses stator windings, and a rotating part known as the rotor. The rotor includes metal bars or rods, which are conductive elements configured to carry induced currents to produce torque. However, heat generated in these bars/rods can lead to several thermal challenges. For example, current flowing through the rods/bars may exhibit resistance that results in copper losses that convert electrical energy into heat. Additionally, higher current densities or increased resistance due to temperature rise can potentially exacerbate the losses and contribute to higher temperatures in the bars/rods. Accordingly, while such systems work well for their intended purpose, there exists an opportunity for improvement in the relevant art.

### SUMMARY

According to one example aspect of the invention, a rotor assembly for an electric machine is provided. In one exemplary implementation, the rotor assembly includes a plurality of rotor laminations arranged in a stacked configuration, and a plurality of apertures formed in each of the rotor laminations, where the plurality of apertures of the plurality of rotor laminations are aligned to form a plurality of passages in the stacked configuration. A conductive rotor bar is disposed in each passage of the plurality of passages, and each conductive rotor bar includes at least one coolant channel formed therein and configured to receive a flow of coolant for cooling the conductive rotor bar.

In addition to the foregoing, the described rotor assembly may include one or more of the following features: a first conductive end ring coupled to a first end of the stacked configuration, and a second conductive end ring coupled to an opposite second end of the stacked configuration, wherein the first and second conductive end rings are conductively coupled to the conductive rotor bars; wherein each of the first and second conductive end rings includes a coolant channel fluidly coupled to the at least one coolant channel of each conductive rotor bar; and wherein the coolant channel each of the first and second conductive end rings includes an annular manifold channel, and a plurality of inlet/outlet channels each fluidly coupled between the annular manifold channel and the at least one coolant channel of one of the conductive rotor bars.

In addition to the foregoing, the described rotor assembly may include one or more of the following features: wherein the plurality of apertures extend radially in a circumferential arrangement about the rotor lamination; wherein the at least one coolant channel of each conductive rotor bar is disposed centrally along a midline of the conductive rotor bar; wherein the conductive rotor bars and the first and second end rings are fabricated from an electrically conductive material; and wherein the electrically conductive material is aluminum or copper.

According to another example aspect of the invention, a method of manufacturing a rotor assembly for an induction machine is provided. In one implementation, the method includes providing a plurality of rotor laminations, forming each rotor lamination of the plurality of rotor laminations with a plurality of apertures, and arranging the rotor laminations of the plurality of rotor laminations in a stacked configuration with the plurality of apertures of each rotor lamination aligned, to thereby form a plurality of passages in the stacked configuration. A conductive rotor bar is disposed in each passage of the plurality of passages, and each conductive rotor bar includes at least one coolant channel formed therein and configured to receive a flow of coolant for cooling the conductive rotor bar.

In addition to the foregoing, the described method may include one or more of the following features: coupling a first conductive end ring to a first end of the stacked configuration, and coupling a second conductive end ring to an opposite second end of the stacked configuration, wherein the first and second conductive end rings are conductively coupled to the conductive rotor bars; wherein each of the first and second conductive end rings includes a coolant channel fluidly coupled to the at least one coolant channel of each conductive rotor bar; and wherein the coolant channel each of the first and second conductive end rings includes an annular manifold channel, and a plurality of inlet/outlet channels each fluidly coupled between the annular manifold channel and the at least one coolant channel of one of the conductive rotor bars.

In addition to the foregoing, the described method may include one or more of the following features: wherein the plurality of apertures extend radially in a circumferential arrangement about the rotor lamination; wherein the at least one coolant channel of each conductive rotor bar is disposed centrally along a midline of the conductive rotor bar; wherein the conductive rotor bars and the first and second end rings are fabricated from an electrically conductive material; and wherein the electrically conductive material is aluminum or copper.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a cross-sectional view of a portion of an example electric motor for an electric vehicle, in accordance with the principles of the present application;

FIG. 2 is a perspective view of a partial rotor assembly of the electric motor of FIG. 1, in accordance with the principles of the present application;

FIG. 3 is a side view of a portion of an example rotor lamination that may be utilized in the electric motor of FIG. 1, in accordance with the principles of the present application;

FIG. 4 illustrates various example cross-sectional shapes of coolant channels that may be formed in rotor bars of a rotor assembly of the electric motor of FIG. 1, in accordance with the principles of the present application; and

FIG. 5 illustrates an example method of forming a rotor assembly that may be utilized in the electric motor of FIG. 1, in accordance with the principles of the present application.

### DESCRIPTION

As previously described, thermal issues in the rotor bars/rods of a squirrel cage induction machine are primarily related to heat generated during the operation of the induction machine. The rotor bars/rods, which are the conductive elements embedded in the rotor cage, play a crucial role in carrying the induced currents and contributing to the induction machine torque production. However, excessive heat in the rotor bars/rods can potentially lead to performance issues. Accordingly, described herein are systems and method of manufacturing induction machines, such as electric traction motors, with a rotor assembly design to improve cooling and overall performance.

In one example, the rotor is assembled from a plurality of steel laminations each formed with a plurality of apertures to receive the rotor bars/rods. Advantageously, instead of solid bars/rods, the rotor bars/rods are formed with one or more channels configured to receive a flow of cooling liquid to maximize heat rejection to improve thermal performance. The rotor assembly includes opposed end rings in fluid communication with the channels. One end ring is utilized as a coolant inlet, and the other as a coolant outlet. Advantageously, the channels are centrally located and relatively small compared to the overall size of the bar/rod. Accordingly, because the current is focused on the bar/rod outer surface, due to the skin effect, there is minimal to no impact from the coolant channels on the induction machine performance.

As such, the described system improves cooling of squirrel cage type induction machine rotors by utilizing rotor bars/rods with coolant channels rather than solid bars/rods. Allowing the cooling fluid to directly pass through the bars/rods maximizes heat extraction and thermal performance. The shape, number, and arrangement of the cooling channels can vary, for example, based on the required cooling flow rate, heat generated in the bars/rods, and the pressure drop. The end rings are utilized to distribute the coolant, with one end ring used as an inlet for the coolant to distribute the coolant to all the coolant channels, and the other end ring used as an outlet to return the heated coolant to a coolant circuit.

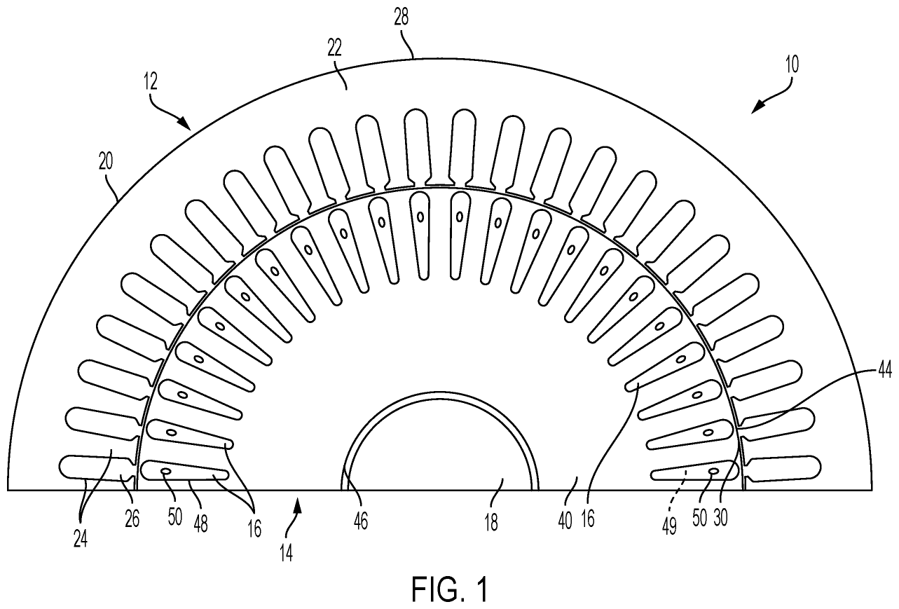

Referring now to FIG. 1, a portion of an example induction machine is illustrated and generally identified at reference numeral 10. In the example embodiments, the induction machine 10 is described as an electric traction motor for an electric vehicle, but it will be appreciated that the features described herein may be applied to various induction machines.

In the illustrated example, the induction machine 10 generally includes a stator assembly 12 operably associated with a rotor assembly 14 having a plurality of internally cooled rotor bars/rods 16, which are described herein in more detail. In general, the stator assembly 12 receives electrical power to produce a magnetic field, which interacts with a magnetic field of the rotor assembly 14 to produce mechanical power to a shaft 18.

In the example embodiment, the stator assembly 12 is formed from a plurality of individual annular stator laminations 20 (only one shown). The stator laminations 20 are stacked one on top of the other to a length known as the stack length, which determines the torque and power output of the induction machine 10. The stator laminations 20 are coupled together, for example, by gluing, interlocking, welding, or other suitable joining technique. The number of stator laminations 20 of the stack length can be based on design considerations and, as such, stator assembly 12 may have any suitable number of stator laminations 20.

In the illustrated example, each stator lamination 20 is fabricated from a magnetic steel in a punching die, laser cut, 3D printing, etc. (not shown) to produce a generally annular component (only half shown) having a back iron 22 with a plurality radially aligned teeth 24 extending radially inward from the back iron 22. The stator teeth 24 define slots 26 therebetween through which coil windings (not shown) are wound. The back iron 22 defines an outer diameter 28, and the distal end of each stator tooth 24 defines an inner diameter edge 30.

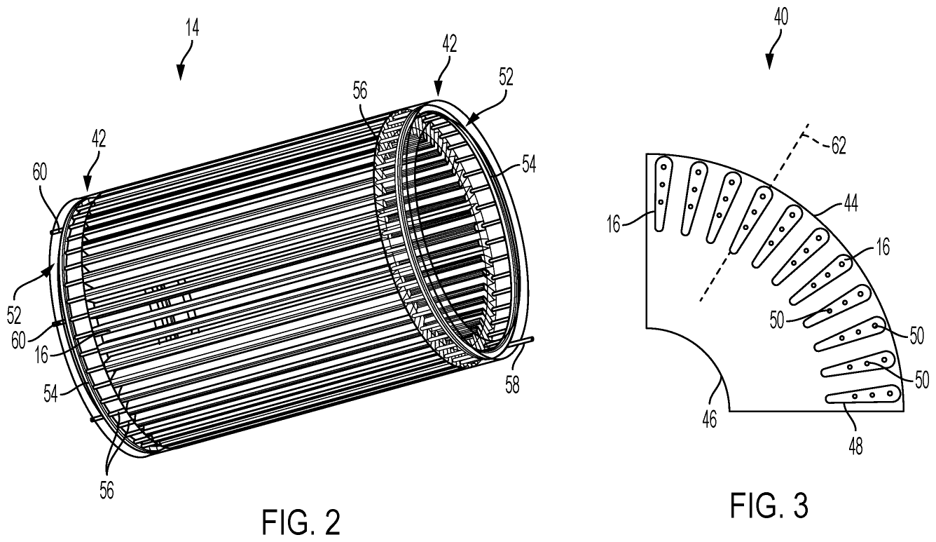

With additional reference to FIG. 2, in the example embodiment, the rotor assembly 14 is formed from a plurality of individual annular rotor laminations 40 with a pair of opposed short-circuit rings or end rings 42. The rotor laminations 40 are stacked one on top of the other to a stack length, which further determines the torque and power output of the induction machine 10. The rotor laminations 40 are coupled together, for example, by gluing, interlocking, welding, or other suitable joining technique. The number of rotor laminations 40 of the stack length can be based on design considerations and, as such, rotor assembly 14 may have any suitable number of rotor laminations 40.

With continued reference to FIG. 1, in the illustrated example, each rotor lamination 40 is fabricated from a magnetic steel in a punching die, laser cut, 3D printing, etc. (not shown) to produce a generally circular or annular component (only half shown) having an outer diameter 44, an inner diameter 46, and a plurality of slots or apertures 48 for receiving one or more of the rotor bars 16. The outer diameter 44 faces the stator inner diameter edge 30, and the inner diameter 46 receives and is mechanically coupled (e.g., splined) to the shaft 18. During assembly, the rotor laminations 40 are stacked such that the apertures 48 are aligned to define passages 49 for receiving the rotor bars 16 through the stacked configuration.

With continued reference to FIG. 2, the stack of rotor laminations 40 are disposed between the opposed end rings 42. However, it will be appreciated that FIG. 2 does not illustrate the rotor laminations 40 in order to clearly show the arrangement of the rotor bars/rods 16 between the opposed end rings 42. The rotor bars/rods 16 are made of electrically conductive materials such as, for example, aluminum or copper. In the example embodiment, the rotor bars/rods 16 extend parallel to the shaft 18 and are evenly spaced around the circumference of the rotor assembly 14. However, in some embodiments, the rotor bars/rods 16 may be skewed and oriented at an angle relative to the longitudinal axis of the shaft 18. Further, in some embodiments, the rotor bars/rods 16 may have uneven spacing, for example, to improve the harmonics content. The conductive rotor bars/rods 16 are connected at each end by the end rings 42, which are also made from a conductive material (e.g., copper or aluminum), thereby creating a closed-loop circuit.

In the example embodiment, the rotor bars/rods 16 may be fabricated from various processes dependent on design factors such as, for example, the induction machine design, application, manufacturing processes, and desired performance. For example, the rotor bars/rods 16 may be fabricated via die casting, extrusion, welding and brazing, or casting. In the die casting process, molten metal is injected into molds to create the rotor bars/rods 16 and end rings 42. Extrusion involves forcing metal through a shaped die to create continuous lengths of rotor bars/rods 16, which can then be cut to a required length and manipulated to match the rotor core curvature. Welding and brazing include welding or brazing individual rotor bars/rods together to form the end rings 42 and closed loop circuits. Casting involves pouring molten metal into molds to create the rotor bars/rods and end rings, for example to produce complex shapes and larger induction machines.

As shown in FIGS. 1 and 3, the rotor bars/rods 16 are formed with one or more coolant channels 50 configured to receive a flow of coolant such as, for example, a cooling oil. Additionally, as shown in FIG. 2, each end ring 42 is also formed with one or more coolant channels 52, which are fluidly connected to the rotor bar coolant channels 50 for circulating the coolant therethrough. In the illustrated example, the end plate coolant channels 52 include an annular manifold channel 54 fluidly connected to a plurality of circumferentially distributed inlet/outlet channels 56, which fluidly connect to the cooling channel(s) 50 of individual rotor bars/rods 16. In this way, one end ring 42 functions as a coolant inlet and the other end ring 42 functions as a coolant outlet. The end rings 42 may be fluidly coupled to a larger coolant circuit (not shown) that provides coolant to other additional components, such as an electric motor gearbox or stator windings (not shown).

With continued reference to FIG. 2, in operation, the coolant is supplied to the inlet end ring 42 through one or more main inlets 58. The coolant then passes through and around the annular manifold channel 54, and subsequently through the inlet channels 56 while cooling the inlet end ring 42. The coolant then passes from the inlet channels 56 into the cooling channel(s) 50 of each individual rotor bar/rod 16. As the coolant is directed from one end of the rotor bar/rod 16 to the opposite end, the coolant absorbs heat generated by current passing through the rotor bar/rod 16. The heated coolant then passes from the cooling channel(s) 50 of each individual rotor bar/rod 16 into the outlet channels 56 of the outlet end ring 42. The heated coolant passes through the annular manifold channel 54, further absorbing heat energy and cooling the outlet end ring 42, and is finally directed out of the rotor assembly 14 via one or more main outlets 60. The heated coolant is subsequently cooled (e.g., via a heat exchanger) and returned to the inlet end ring 42 to repeat the cooling process.

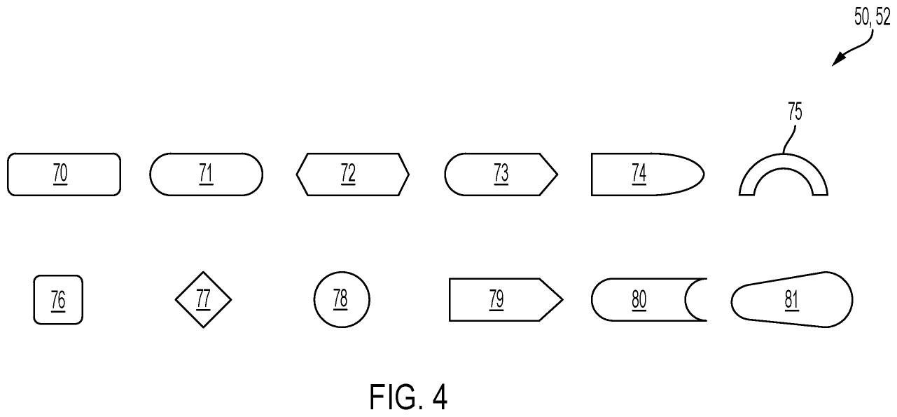

Although FIGS. 1-3 and the accompanying description show and describe various patterns and configurations for coolant channels 50, 52, it will be appreciated that various other patterns and configurations of coolant channels 50, 52 are envisioned based on various design factors such as thermal requirements. For example, although coolant channels 50 are shown symmetrically disposed on a midline 62 of the rotor bar/rod 16 (e.g., FIG. 3), the cooling channel(s) 50 may be disposed in any location of the rotor bar/rod 16 and may have various sizes and shapes, as shown in FIG. 4.

With reference now to FIG. 4, various example cross-sectional shapes of coolant channels 50, 52 are illustrated. The example coolant channel shapes include a rectangular shape 70, an elongated oval shape 71, a polygonal shape such as a triangular-ended rectangular shape 72, a rectangular shape with rounded and triangular ends 73, a bullet shape 74, a semi-circular shape 75, a square shape 76, a diamond shape 77, a circular shape 78, an arrow-like shape 79, a rectangular shape with convex and concave ends 80, and an airfoil shape or rectangular shape with different sized rounded ends 81. However, it will be appreciated that coolant channels 50, 52 are not limited to the described shapes and could have various other shapes. Moreover, it will also be appreciated that each rotor bar/rod 16 may have various combinations of shapes.

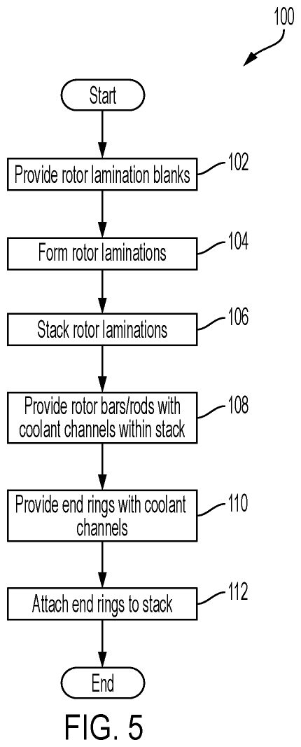

FIG. 5 illustrates an example method 100 of manufacturing rotor assembly 14. The method begins at step 102 where a plurality of rotor lamination blanks is provided. At step 104, each rotor lamination blank is processed and formed with outer diameter 44, inner diameter 46, and apertures 48 to produce a plurality of rotor laminations 40. In the example embodiment, the rotor laminations 40 are formed in a die press operation. At step 106, the rotor laminations 40 are stacked and coupled with apertures 48 aligned to form a stacked configuration.

At step 108, rotor bars/rods 16 are formed or provided with one or more of coolant channels 50 extending therethrough, and arranged within passages 49 formed by the aligned apertures 48 of the stacked configuration. In one example, features (not shown) to form the channels 50 are inserted into the passages 49, and molten metal is then poured into the passages 49 and allowed to cool. In another example, the rotor bars/rods 16 are formed with coolant channel(s) 50 and subsequently inserted into apertures 48. At step 110, the opposed end rings 42 are formed or provided with coolant channels 52. At step 112, the opposed end rings 42 are coupled to the ends of the stack of rotor laminations 40 such that coolant channels 50 and 52 are fluidly coupled and the rotor bars/rods 16 are electrically connected via the end rings 42.

Described herein are systems and methods for manufacturing induction machines, such as electric traction motors, with improved rotor cooling. The induction machine rotor is assembled from a plurality of magnetic steel laminations each formed with a plurality of apertures configured to be aligned. Each set of aligned apertures receives a rotor bar/rod with one or more coolant channels formed therein. A pair of end rings are attached to both ends of the lamination stack. The end rings include coolant channels fluidly connected to the coolant channels of the rotor bars/rods. A coolant is supplied through the first end ring, through the plurality of rotor bars/rods, and finally through the second end ring to thereby cool the rotor bars/rods and end rings to improve performance of the induction machine.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A rotor assembly for an electric machine, the rotor assembly comprising:
a plurality of rotor laminations arranged in a stacked configuration;
a plurality of apertures formed in each of the rotor laminations, wherein the plurality of apertures of the plurality of rotor laminations are aligned to form a plurality of passages in the stacked configuration; and
a conductive rotor bar disposed in each passage of the plurality of passages, wherein each conductive rotor bar includes at least one coolant channel formed therein and configured to receive a flow of coolant for cooling the conductive rotor bar.

2. The rotor assembly of claim 1, further comprising:
a first conductive end ring coupled to a first end of the stacked configuration; and
a second conductive end ring coupled to an opposite second end of the stacked configuration,
wherein the first and second conductive end rings are conductively coupled to the conductive rotor bars.

3. The rotor assembly of claim 2, wherein each of the first and second conductive end rings includes a coolant channel fluidly coupled to the at least one coolant channel of each conductive rotor bar.

4. The rotor assembly of claim 3, wherein the coolant channel each of the first and second conductive end rings comprises:
an annular manifold channel; and
a plurality of inlet/outlet channels each fluidly coupled between the annular manifold channel and the at least one coolant channel of one of the conductive rotor bars.

5. The rotor assembly of claim 1, wherein the plurality of apertures extend radially in a circumferential arrangement about the rotor lamination.

6. The rotor assembly of claim 1, wherein the at least one coolant channel of each conductive rotor bar is disposed centrally along a midline of the conductive rotor bar.

7. The rotor assembly of claim 2, wherein the conductive rotor bars and the first and second end rings are fabricated from an electrically conductive material.

8. The rotor assembly of claim 7, wherein the electrically conductive material is aluminum or copper.

9. A method of manufacturing a rotor assembly for an induction machine, the method comprising:
providing a plurality of rotor laminations;
forming each rotor lamination of the plurality of rotor laminations with a plurality of apertures;
arranging the rotor laminations of the plurality of rotor laminations in a stacked configuration with the plurality of apertures of each rotor lamination aligned, to thereby form a plurality of passages in the stacked configuration; and
disposing a conductive rotor bar in each passage of the plurality of passages, wherein each conductive rotor bar includes at least one coolant channel formed therein and configured to receive a flow of coolant for cooling the conductive rotor bar.

10. The method of claim 9, further comprising:
coupling a first conductive end ring to a first end of the stacked configuration; and
coupling a second conductive end ring to an opposite second end of the stacked configuration,
wherein the first and second conductive end rings are conductively coupled to the conductive rotor bars.

11. The method of claim 10, wherein each of the first and second conductive end rings includes a coolant channel fluidly coupled to the at least one coolant channel of each conductive rotor bar.

12. The method of claim 11, wherein the coolant channel each of the first and second conductive end rings comprises:
an annular manifold channel; and
a plurality of inlet/outlet channels each fluidly coupled between the annular manifold channel and the at least one coolant channel of one of the conductive rotor bars.

13. The method of claim 9, wherein the plurality of apertures extend radially in a circumferential arrangement about the rotor lamination.

14. The method of claim 9, wherein the at least one coolant channel of each conductive rotor bar is disposed centrally along a midline of the conductive rotor bar.

15. The method of claim 9, wherein the conductive rotor bars and the first and second end rings are fabricated from an electrically conductive material.

16. The method of claim 15, wherein the electrically conductive material is aluminum or copper.
